(19) United States
(12) Patent Application Publication
(10) Pub. No.: US 2026/0148121 A1
(43) Pub. Date: May 28, 2026

(54) AVOIDING REDUNDANT DATA DECODING AND DATA TRANSFORMATION OF PREPROCESSED TENSOR DATA

(71) Applicant: Dell Products L.P., Round Rock, TX (US)

(72) Inventors: Qi Bao, Acton, MA (US); Gaurav Chawla, Austin, TX (US); Emine Ugur Kaynar Terzioglu, Boston, MA (US)

(21) Appl. No.: 18/956,975

(22) Filed: Nov. 22, 2024

(51) Int. Cl. G06N 20/00

(52) U.S. Cl. CPC G06N 20/00

(57) ABSTRACT

The technologies described herein are generally directed toward the avoidance of redundant data decoding and transformation of preprocessed tensor data. For instance, a system can enable performance of operations including, during a first training epoch for a model, receiving, by the system, a tensor, with the tensor being generated based on transforming raw data. The operations may further include storing, by the system, the tensor, resulting in a cached tensor. Further, the operations may include, before a second training epoch for the model, inputting, by the system, the cached tensor to a model training process of the model.

### BACKGROUND

Modern systems that implement artificial intelligence (AI)/machine learning (ML) systems may require repetitive and computationally intensive operations to be performed. Many of these operations occur at the training phase, where training data is used to train and update complex models over time. Often overlooked, however, are the storage and processor intensive operations that are used to generate the training data from raw data.

In some circumstances, the operations used to generate training data may unexpectedly increase in complexity over time, and, in response, model developers may simply allocate more computational resources to these operations without considering other approaches. Problems resulting from inefficient generation of training data may be aggravated as the use of raw data that includes complex multimedia continues to increase.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include, during a first training epoch for a model, receiving, by a system comprising at least one processor, a tensor, with the tensor being generated based on a transformation of raw data. The method may further include, storing, by the system, the tensor, resulting in a cached tensor. Further, the method may include, before a second training epoch for the model, inputting, by the system, the cached tensor to a model training process of the model.

In addition or alternative embodiments, the method may include, receiving a request to commence the first training epoch using the tensor, determining that the tensor is not stored, and, based on the tensor not being stored, requesting the tensor, with the receiving of the tensor resulting from the requesting of the tensor. In additional or alternative embodiments, the tensor was generated based on the tensor being requested. In additional or alternative embodiments, the method may further include, receiving a request to commence the second training epoch using the tensor, and determining that the tensor is stored as the cached tensor, the inputting of the cached tensor being based on the determination that the tensor is stored.

In additional or alternative embodiments, the method may further include, determining, by the system, that the raw data that was used to generate the cached tensor has not been changed since the cached tensor was generated, with the inputting of the cached tensor being further based on the determining that the raw data has not been changed. In additional or alternative embodiments, the method may further include, determining that the raw data that was used to generate the cached tensor has changed since the cached tensor was generated, resulting in changed raw data, requesting that an updated tensor be generated based on the changed raw data, and storing the updated tensor, resulting in a cached updated tensor.

In additional or alternative embodiments, the model may be a first model, and the model training process may be a first model training process. In additional or alternative embodiments, the method may further include, receiving a request to commence a training epoch for a second model using the raw data, determining, by the system, that the raw data was used to generate the cached tensor, and inputting, by the system, the cached tensor to a second model training process of the second model. In additional or alternative embodiments, the first model comprises a machine learning model. In additional or alternative embodiments, the tensor may include a multidimensional array used for iterative training of the machine learning model. In additional or alternative embodiments, the storing of the tensor further results in a stored tensor that was stored in non-volatile storage. In additional or alternative embodiments, the storing of the tensor may be based on a processing time for transformation of the raw data into the tensor satisfying a threshold time.

An example system can operate as follows. At least one memory may store computer executable instructions, and at least one processor may be configured to process the computer executable instructions that, when executed by the at least one processor, facilitate performance of operations. The operations may include receiving, from a tensor caching device, tensor data, representative of a tensor, generated by decoding data into a tensor format. The operations may further include storing the tensor data in a chunked tensor format that enables parallel input or output of the tensor data, resulting in stored tensor data. Further, the operations may include receiving, from the tensor caching device, a request to communicate the stored tensor data.

In additional or alternative embodiments, the operations may further include, communicating the stored tensor data to the tensor caching device. In additional or alternative embodiments, before the communicating of the stored tensor data, the operations further comprise determining that the data used to generate the tensor data has not changed since the tensor data was stored. In additional or alternative embodiments, the tensor data was generated for a first epoch of iterative training epochs of a first data model, and wherein the request to provide the stored tensor data was received to communicate training data for a second epoch of the iterative training epochs of the first data model.

In additional or alternative embodiments, the request to communicate the stored tensor data includes a first request, with the operations further including receiving a second request to communicate the stored tensor data, and the second request was received to communicate training data for use in training a second data model.

An example non-transitory machine-readable medium may include executable instructions that, when executed by at least one processor, facilitate performance of operations. The operations may include receiving a multidimensional array that includes model parameters generated based on processing source data, with the multidimensional array being generated for a first training iteration of a machine learning model by a training engine. The operations may further include caching the multidimensional array, resulting in a cached multidimensional array, and providing the cached multidimensional array to the training engine for a second training iteration of the machine learning model.

In additional or alternative embodiments, the operations may further include, providing the multidimensional array to a storage device that stores data in chunked format that enables parallel input or parallel output of the multidimensional array. In additional or alternative embodiments, the providing of the cached multidimensional array to the training engine may include retrieving the multidimensional array from the storage device, resulting in a retrieved multidimensional array, and providing the retrieved multidimensional array to the training engine. In additional or alternative embodiments, the storage device comprises a tensor data store.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate the avoidance of redundant data decoding and transformation of preprocessed tensor data, in accordance with one or more embodiments.

FIG. 2 is an architecture diagram of an example system that can facilitate the avoidance of redundant data decoding and transformation of preprocessed tensor data, in accordance with one or more embodiments.

FIG. 3 is a diagram of an example system that can facilitate the avoidance of redundant data decoding and transformation of preprocessed tensor data, in accordance with one or more embodiments.

FIG. 4 is a flow diagram of an example system that can facilitate the avoidance of redundant data decoding and transformation of preprocessed tensor data, in accordance with one or more embodiments.

FIG. 5 is an example code that can facilitate the avoidance of redundant data decoding and transformation of preprocessed tensor data, in accordance with one or more embodiments.

FIG. 6 depicts a flow diagram representing example operations of an example method that can facilitate the avoidance of redundant data decoding and transformation of preprocessed tensor data, in accordance with one or more embodiments.

FIG. 7 depicts an example system that can facilitate the avoidance of redundant data decoding and transformation of preprocessed tensor data, in accordance with one or more embodiments.

FIG. 8 depicts an example non-transitory machine-readable medium that can include executable instructions that, when executed by a processor of a system, can facilitate the avoidance of redundant data decoding and transformation of preprocessed tensor data, in accordance with one or more embodiments.

FIG. 9 depicts an example schematic block diagram of a computing environment with which the disclosed subject matter can interact.

FIG. 10 illustrates an example block diagram of a computer operable to execute an embodiment of this disclosure.

### DETAILED DESCRIPTION

Generally speaking, one or more embodiments described herein can facilitate the avoidance of redundant data decoding and transformation of preprocessed tensor data, in accordance with one or more embodiments.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

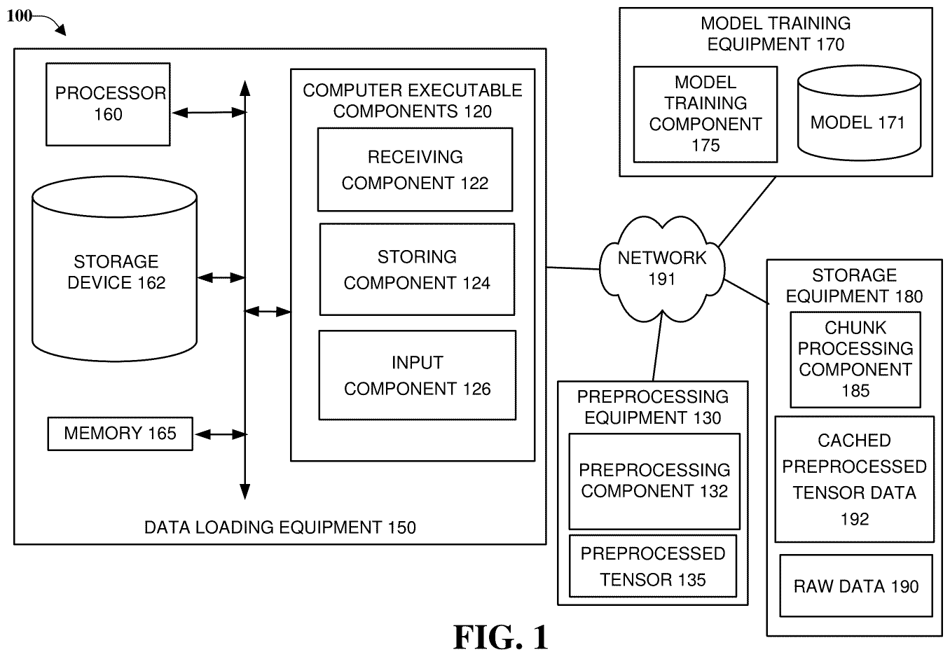

FIG. 1 is an architecture diagram of an example system 100 that can facilitate the avoidance of redundant data decoding and transformation of preprocessed tensor data, in accordance with one or more embodiments. For purposes of brevity, description of like elements and/or processes employed in other embodiments is omitted.

As depicted, system 100 includes data loading equipment 150 connected, via network 191, to model training equipment 170, preprocessing equipment 130, and storage equipment 180. Model training equipment 170 is depicted as operating model training component 175 to train model 171. Preprocessing equipment 130 is depicted as operating preprocessing component 132 with preprocessed tensor 135. Storage equipment 180 is depicted as operating chunk processing component 185 to store cached preprocessed tensor data 192 and raw data 190.

As depicted, data loading equipment 150 can include memory 165 that can store one or more computer and/or machine readable, writable, and/or executable components 120 and/or instructions. In embodiments, data loading equipment 150 can further include processor 160. In one or more embodiments, computer executable components 120, when executed by processor 160, can facilitate performance of operations defined by the executable component(s) and/or instruction(s). Computer executable components 120 can include receiving component 122, storing component 124, input component 126, and other components described or suggested by different embodiments described herein, that can improve the operation of system 100. Data loading equipment 150 may further include storage device 162. In an example, storage device 162 may provide nonvolatile storage of data, data structures, computer executable instructions, and so forth.

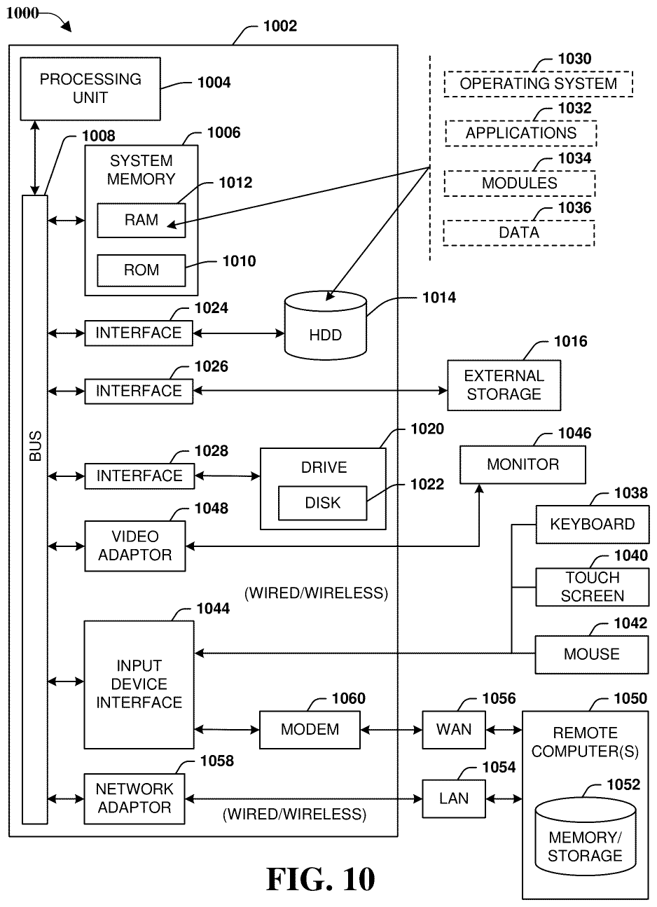

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

As discussed further with FIG. 10 below, network 191 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP 2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

It is understood that the computer processing systems, computer-implemented methods, apparatus, and computer program products described herein employ computer hardware and/or software to solve problems that are highly technical in nature (e.g., analyzing the operation a tensor data loading pipeline in real-time and caching results based on different factors), that are not abstract and cannot be performed as a set of mental acts by a human. For example, a human, or even a plurality of humans, cannot efficiently handle the rapid storage operations described herein, with a level of accuracy and/or efficiency as the various embodiments described herein.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of receiving component 122, which can in some implementations, during a first training epoch for a model, receive a tensor, with the tensor being generated based on a transformation of raw data. For example, in one or more embodiments, during a first training epoch for model 171, receiving component 122 may receive preprocessed tensor 135, from preprocessing equipment 130. In one or more embodiments, the tensor may be based on preprocessing operations performed on raw data 190 by preprocessing component 132.

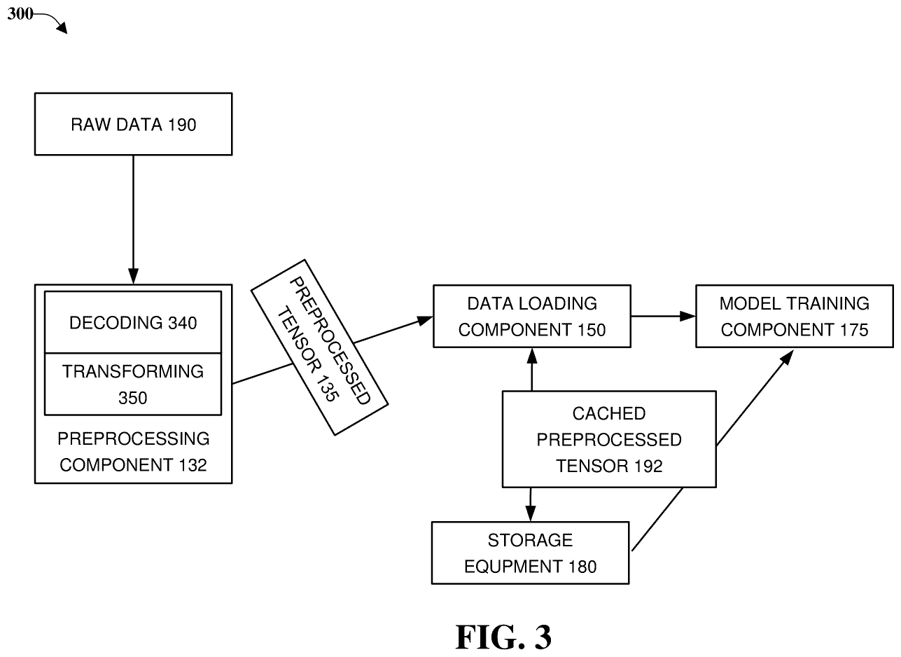

As used herein, preprocessed tensor 135 may be used to describe a multidimensional array that includes model parameters generated based on processing source/raw data 190. To enable models to learn intricate patterns in raw data 190 samples, a training dataset (e.g., preprocessed tensor 135) may have to be used multiple times to train the AI model, e.g., in multiple training epochs. As a result, raw data 190 may need to be repeatedly decoded from raw data and transformed into preprocessed tensor 135 for each of the different training epochs. As described herein, rather than regenerating preprocessed tensor 135 for each training epoch, one or more embodiments may store cached preprocessed tensor data 192 for providing to model training component 175 at each additional training epoch after the first. As described with FIG. 3 below, data preprocessing operations (tasks) may include reading raw data 190 from storage equipment 180, and decoding/transforming raw data 190 into a preprocessed tensor format.

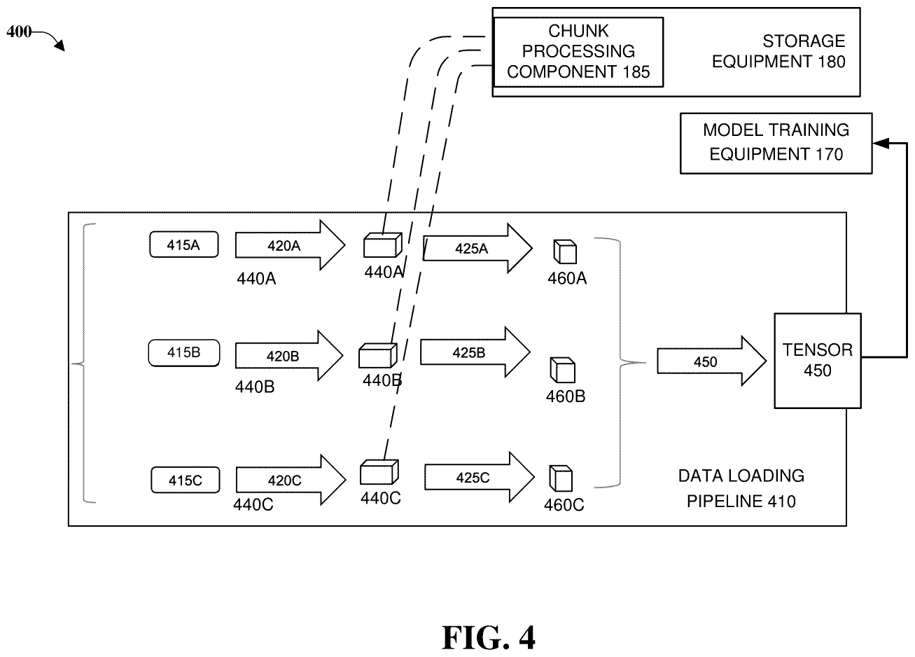

In another example, memory 165 can store executable instructions that can facilitate generation of storing component 124, which can in some implementations store the tensor, resulting in a cached tensor. In one or more embodiments, storing component 124 may store the tensor as cached preprocessed tensor data 192 at storage equipment 180, resulting in cached preprocessed tensor data 192. As described with FIG. 4 below, in some implementations, multiple tensors may be generated by preprocessing component 132 in parallel, and to improve parallel storage operations, chunk processing component 185 may store cached tensors as chunks in the storage of storage equipment 180.

In another example, memory 165 can store executable instructions that can facilitate generation of input component 126, which can in some implementations may, before a second training epoch for the model, input the cached tensor to a model training process of the model. For example, in one or more embodiments, input component 126 may, before a second training epoch for model 171, input the cached preprocessed tensor data 192 to model training component 175.

It is appreciated that the embodiments of the subject disclosure depicted in various figures disclosed herein are for illustration only, and as such, the architecture of such embodiments are not limited to the systems, devices, and/or components depicted therein. For example, in some embodiments, data loading equipment 150, model training equipment 170, preprocessing equipment 130, storage equipment 180, and other devices discussed herein, can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

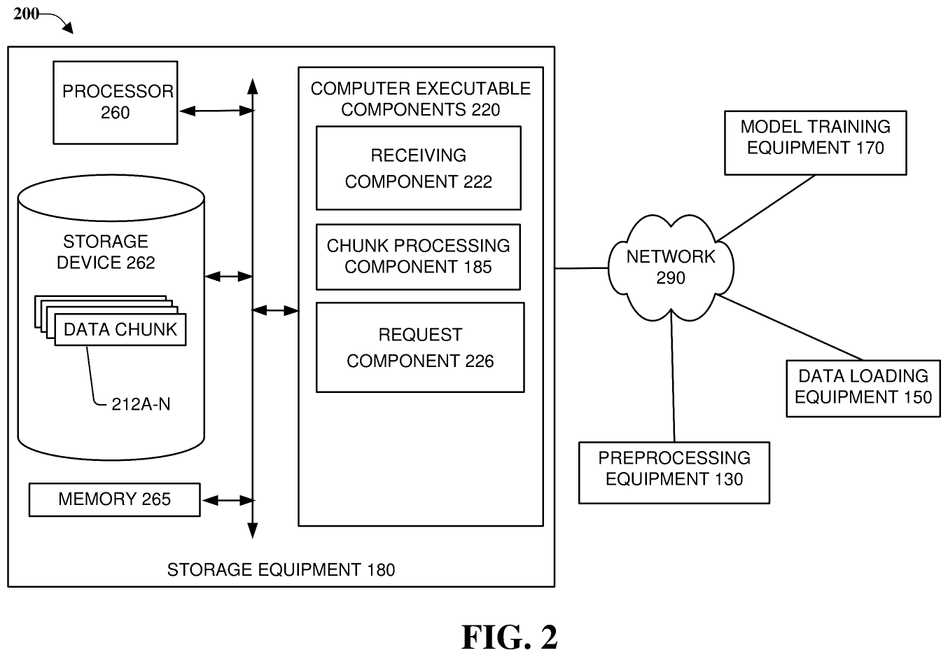

It should be noted that data loading equipment 150, model training equipment 170, preprocessing equipment 130, storage equipment 180, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as data loading equipment 150. For example, one or more of data loading equipment 150, model training equipment 170, preprocessing equipment 130, and storage equipment 180 can all be separate subsystems running in the kernel of a computing device as well as operating on separate network equipment, e.g., as depicted in FIGS. 1 and 2.

FIG. 2 is an architecture diagram of an example system 200 that can facilitate the avoidance of redundant data decoding and transformation of preprocessed tensor data, in accordance with one or more embodiments. For purposes of brevity, description of like elements and/or processes employed in other embodiments is omitted. As depicted, system 100 includes data loading equipment 150 connected, via network 290, to model training equipment 170, preprocessing equipment 130, and storage equipment 180. Storage equipment 180 includes processor 260, memory 265, storage device 262, and computer executable components 220. Storage device 262 includes data chunks 212A-N.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include receiving component 222, chunk processing component 185, request component 226, and other components described or suggested by different embodiments described herein, e.g., that can improve the operation of system 200, in accordance with one or more embodiments.

In an example implementation of storage equipment 180, memory 265 can store executable instructions that can facilitate generation of receiving component 222, which in some implementations, may receive tensor data, representative of a tensor, generated by decoding data into a tensor format. For example, in an embodiment, receiving component 222 may receive cached preprocessed tensor data 192, representative of a tensor, from storing component 124, generated by a decoding operation performed by preprocessing component 132.

In an example implementation of storage equipment 180, memory 265 can further store executable instructions that can facilitate generation of chunk processing component 185, which in some implementations, may store the tensor data in a chunked tensor format that enables parallel input or output of the tensor data, resulting in stored tensor data. In an example, chunk processing component 185 may store the tensor data in a chunked tensor format that enables parallel input or output of the tensor data, resulting in stored tensor data.

In an example implementation of storage equipment 180, memory 265 can further store executable instructions that can facilitate generation of request component 226, which in some implementations, may receive, from the tensor caching device, a request to communicate the stored tensor data. In an example, request component 226 may receive from the data loading equipment 150, a request to communicate the stored tensor data. In an example, storage equipment 180 may communicate cached preprocessed tensor data 192, stored as data chunks 215A-N to data loading equipment 150. In this example, cached preprocessed tensor data 192 may be communicated to data loading equipment 150 for additional processing, e.g., tensor data augmentation operations, discussed with FIG. 4 below.

FIG. 3 is a diagram of an example system 300 that can facilitate the avoidance of redundant data decoding and transformation of preprocessed tensor data, in accordance with one or more embodiments. For purposes of brevity, description of like elements and/or processes employed in other embodiments is omitted. As depicted, data loading equipment 150 is coupled to model training component 175, storage equipment 180, and preprocessing component 132, which is coupled to raw data 190.

In one or more embodiments, automatic caching of tensor data by data loading equipment 150 in a first epoch of model training may avoid redundant tensor transformation for later epochs. In an implementation, during a first epoch of training, for every data sample, data loading equipment 150 may cache decoded and transformed tensor data. An approach to caching the transformed data persists the data in a tensor storage system, e.g., storage equipment 180.

As depicted in FIG. 3, in a first training epoch, preprocessing component 132 receives raw data 190. As used herein, preprocessing operations may broadly refer to different operations used to generate model training data (e.g., cached preprocessed tensor data 192) from raw data 190, e.g., decoding 340 and transforming 350 operations. Preprocessed tensor 135 is communicated to data loading equipment 150 which, in some implementations, may be used both to input preprocessed tensor 135 to model training component 175 and store preprocessed tensor 135 in storage equipment 180 as cached preprocessed tensor data 192.

After the first training epoch, use of cached preprocessed tensor data 192 may be facilitated by a request provided to storage equipment 180 for the communication of cached preprocessed tensor data 192 either, as depicted in FIG. 3, to data loading equipment 150 or directly to model training component 175. In additional implementations, the request to communicate cached preprocessed tensor data 192 may include a request to communicate cached preprocessed tensor data 192 for use in training a second instance of model 171 or a different AI/ML model. In one or more embodiments, the flexible use of cached preprocessed tensor data 192 may be facilitated by persisting cached preprocessed tensor data 192 at storage equipment 180 in and AI/ML framework that is agnostic and open format, e.g., for use with different model training components and models. In some implementations, the training dataset used by model training component 175 may be automatically augmented with cached tensors stored in the open format, e.g., facilitating the sharing and reusing of tensor data.

FIG. 4 is a flow diagram of an example system 400 that can facilitate the avoidance of redundant data decoding and transformation of preprocessed tensor data, in accordance with one or more embodiments. For purposes of brevity, description of like elements and/or processes employed in other embodiments is omitted. As depicted, data loading pipeline 410 includes raw data 415A-C, data transformation operations 420A-C, tensors 440A-C, tensor augmenting operations 425A-C, augmented tensors 460A-C, and input tensor 450. Data loading pipeline 410 is coupled to model training equipment 170.

As described herein, AI/ML training workloads may be storage and computationally intensive, especially for multimedia data types such as images and videos. To feed training data to AI/ML models, one or more embodiments may use data loading pipeline 410 to perform a series of data preprocessing tasks, including reading raw data 415A-C from storage, decoding/transforming 420A-C the raw data into a tensor format 440A-C. As depicted in FIG. 4, to improve the speed and efficiency of the tensor caching operations described herein, one or more embodiments may use chunk processing component 185 to store cached preprocessed tensor data 192 in a chunked format, e.g., enabling parallel input or parallel output of the cached preprocessed tensor data 192. In some implementations, chunk processing component 185 may include a multi-threaded fetching mechanism that handles an asynchronous storage connector that may read and write multiple chunks of a tensor in parallel.

In an alternate example, tensor format 440A-C represents slices of a tensor generate from raw data 415A-C. By facilitating the manipulation of slices of cached preprocessed tensor data 192, one or more embodiments support reading selected slices of a tensor so as to, in some circumstances, avoid reading whole tensor.

Continuing the description of data loading pipeline 410, one or more embodiments support data augmentation operations 425A-C being performed on tensor format 440A-C whether initially received from preprocessing component 132 or received as cached preprocessed tensor data 192 from storage equipment 180. Example augmentation operations 425A-C include, but are not limited to, cropping image tensors, and rotating image tensors.

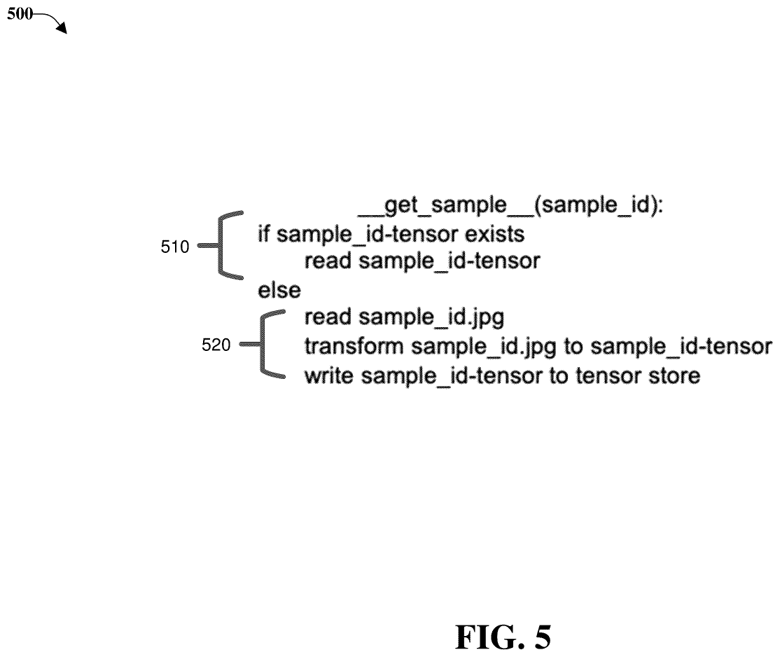

FIG. 5 is an example code 500 that can facilitate the avoidance of redundant data decoding and transformation of preprocessed tensor data, in accordance with one or more embodiments. For purposes of brevity, description of like elements and/or processes employed in other embodiments is omitted.

In one or more embodiments, data loading equipment 150 may determine to either read (or reread) raw data 190 if tensor data is not yet cached for the data or read cached preprocessed tensor data 192 directly from storage equipment 180, thereby avoiding the performance of redundant decoding and transformation for the already cached preprocessed tensor data 192.

For example, at 510, in response to a request for tensor data corresponding to raw data 190 (e.g., sample_id.jpg), a determination may be made, by the system, that sample_id.jpg was used to generate a cached tensor that has not been changed since the cached tensor was generated and cached. Because of this determination, sample_id-tensor may be read by the system and communicated to model training component 175 for use in a training epoch.

Alternatively, at 520, when a determination is made that no cached tensor for sample_id.jpg has been stored, a request may be made to preprocessing equipment 130 requesting that an initial (or updated) tensor be generated based on transforming the sample_id.jpg to sample_id-tensor. After this generation, the sample_id-tensor may be stored as preprocessed cached preprocessed tensor data 192 for use in subsequent training epochs.

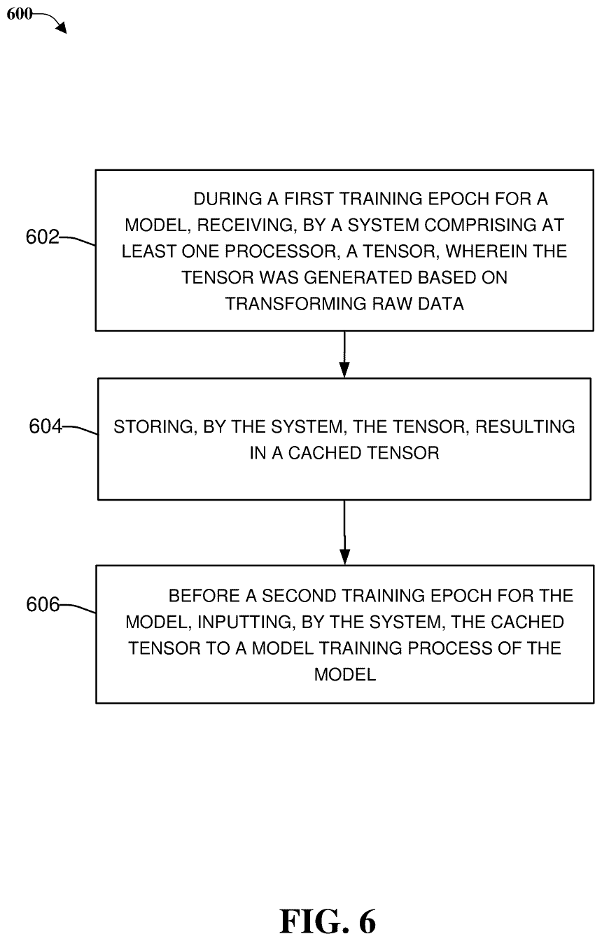

FIG. 6 depicts a flow diagram representing example operations of an example method 600 that can facilitate the avoidance of redundant data decoding and transformation of preprocessed tensor data, in accordance with one or more embodiments. For purposes of brevity, description of like elements and/or processes employed in other embodiments is omitted.

In some examples, one or more embodiments of method 600 can be implemented by receiving component 122, storing component 124, input component 126, and other components that can be used to implement aspects of method 600, in accordance with one or more embodiments. It is appreciated that the operating procedures of method 600 are example operating procedures, and that there can be embodiments that implement more or fewer operating procedures than are depicted, or that implement the depicted operating procedures in a different order than as depicted.

At 602 of method 600, receiving component 122 of data loading equipment 150 can, in one or more embodiments, receive a tensor, with the tensor being generated based on a transformation of raw data. At 604 of method 600, storing component 124 can, in one or more embodiments store the tensor, resulting in a cached tensor. At 606 of method 600, input component 126 can, in one or more embodiments, before a second training epoch for the model, input, by the system, the cached tensor to a model training process of the model.

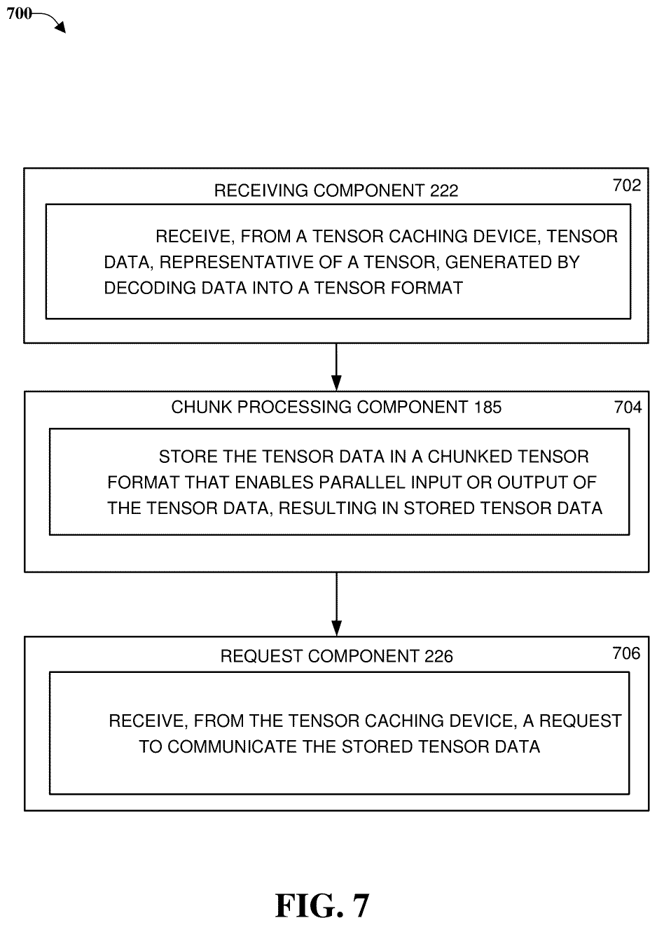

FIG. 7 depicts an example system 700 that can facilitate the avoidance of redundant data decoding and transformation of preprocessed tensor data, in accordance with one or more embodiments. For purposes of brevity, description of like elements and/or processes employed in other embodiments is omitted.

Example system 700 can include receiving component 222, chunk processing component 185, request component 226, and other components that can be used to implement aspects of system 700, as described herein, in accordance with one or more embodiments. At 702 of FIG. 7, receiving component 222 can receive, from a tensor caching device, tensor data, representative of a tensor, generated by decoding data into a tensor format. At 704 of FIG. 7, chunk processing component 185 can store the tensor data in a chunked tensor format that enables parallel input or output of the tensor data, resulting in stored tensor data. At 706 of FIG. 7, request component 226 can receive, from the tensor caching device, a request to communicate the stored tensor data.

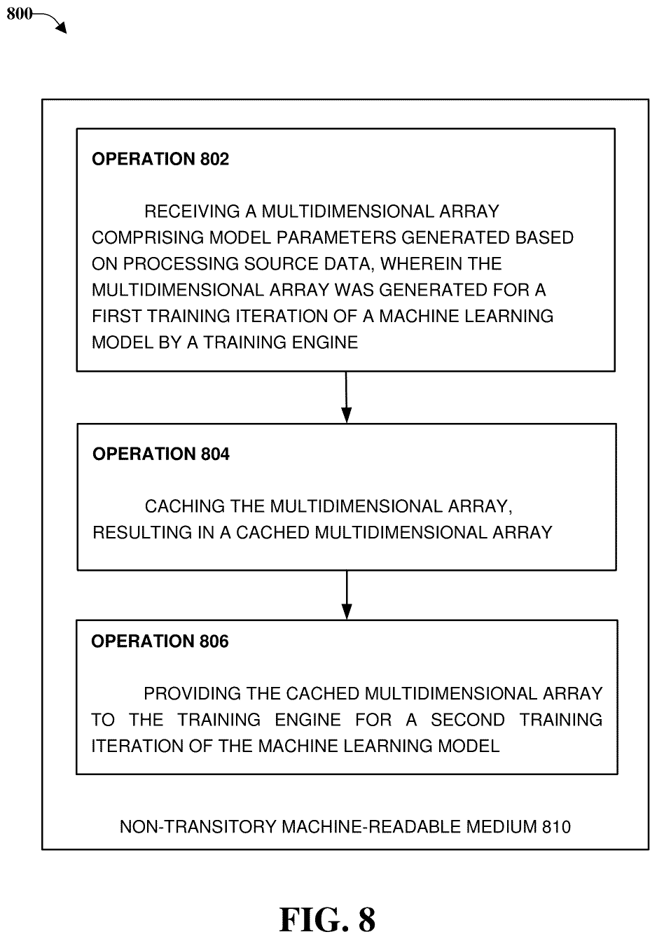

FIG. 8 depicts an example 800 non-transitory machine-readable medium 810 that can include executable instructions that, when executed by a processor of a system, can facilitate the avoidance of redundant data decoding and transformation of preprocessed tensor data, in accordance with one or more embodiments. For purposes of brevity, description of like elements and/or processes employed in other embodiments is omitted.

As depicted, non-transitory machine-readable medium 810 includes comprising executable instructions that, when executed by at least one processor of a data loading device, facilitate performance of operations that include receiving a multidimensional array comprising model parameters generated based on processing source data, with the multidimensional array being generated for a first training iteration of a machine learning model by a training engine. The operations may further include operation 804 which, in one or more embodiments includes caching the multidimensional array, resulting in a cached multidimensional array. The operations may further include operation 806 which, in one or more embodiments includes providing the cached multidimensional array to the training engine for a second training iteration of the machine learning model.

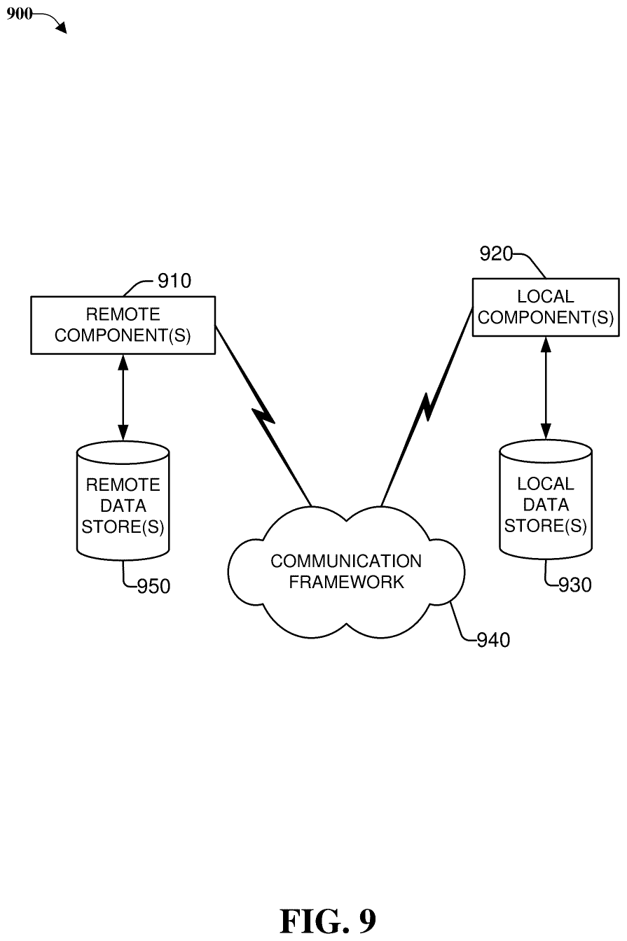

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
during a first training epoch for a model, receiving, by a system comprising at least one processor, a tensor, wherein the tensor was generated based on transforming raw data;
storing, by the system, the tensor, resulting in a cached tensor; and
before a second training epoch for the model, inputting, by the system, the cached tensor to a model training process of the model.

2. The method of claim 1, further comprising:
receiving, by the system, a request to commence the first training epoch using the tensor;
determining, by the system, that the tensor is not stored; and
based on the tensor not being stored, requesting, by the system, the tensor, wherein the receiving of the tensor results from the requesting of the tensor.

3. The method of claim 2, wherein the tensor was generated based on the requesting of the tensor.

4. The method of claim 1, further comprising:
receiving, by the system, a request to commence the second training epoch using the tensor; and
determining, by the system, that the tensor is stored as the cached tensor, wherein the inputting of the cached tensor is based on the determining that the tensor is stored.

5. The method of claim 4, further comprising, determining, by the system, that the raw data that was used to generate the cached tensor has not changed since the cached tensor was generated, wherein the inputting of the cached tensor is further based on the determining that the raw data has not been changed.

6. The method of claim 4, further comprising:
determining, by the system, that the raw data that was used to generate the cached tensor has changed since the cached tensor was generated, resulting in changed raw data;
requesting, by the system, that an updated tensor be generated based on the changed raw data; and
storing, by the system, the updated tensor resulting in a cached updated tensor.

7. The method of claim 1, wherein the model is a first model, wherein the model training process is a first model training process, and further comprising:
receiving, by the system, a request to commence a training epoch for a second model using the raw data;
determining, by the system, that the raw data was used to generate the cached tensor; and
inputting, by the system, the cached tensor to a second model training process of the second model.

8. The method of claim 7, wherein the first model comprises a machine learning model.

9. The method of claim 8, wherein the tensor comprises a multidimensional array used for iterative training of the machine learning model.

10. The method of claim 1, wherein the storing of the tensor further results in a stored tensor that was stored in non-volatile storage.

11. The method of claim 1, wherein the storing of the tensor is based on a processing time for transformation of the raw data into the tensor satisfying a threshold time.

12. A computing system, comprising:
at least one memory that stores computer executable instructions; and
at least one processor configured to process the computer executable instructions that, when executed by the at least one processor, facilitate performance of operations, comprising:
receiving, from a tensor caching device, tensor data, representative of a tensor, generated by decoding data into a tensor format,
storing the tensor data in a chunked tensor format that enables parallel input or output of the tensor data, resulting in stored tensor data, and
receiving, from the tensor caching device, a request to communicate the stored tensor data.

13. The computing system of claim 12, wherein the operations further comprise communicating the stored tensor data to the tensor caching device.

14. The computing system of claim 13, wherein, before the communicating of the stored tensor data, the operations further comprise determining that the data used to generate the tensor data has not changed since the tensor data was stored.

15. The computing system of claim 12, wherein the tensor data was generated for a first epoch of iterative training epochs of a first data model, and wherein the request to provide the stored tensor data was received to communicate training data for a second epoch of the iterative training epochs of the first data model.

16. The computing system of claim 15, wherein the request to communicate the stored tensor data comprises a first request, wherein the operations further comprise receiving a second request to communicate the stored tensor data, and wherein the second request was received to communicate training data for use in training a second data model.

17. A non-transitory machine-readable medium comprising executable instructions that, when executed by at least one processor of a data loading device, facilitate performance of operations, the operations comprising:
receiving a multidimensional array comprising model parameters generated based on processing source data, wherein the multidimensional array was generated for a first training iteration of a machine learning model by a training engine;
caching the multidimensional array, resulting in a cached multidimensional array; and
providing the cached multidimensional array to the training engine for a second training iteration of the machine learning model.

18. The non-transitory machine-readable medium of claim 17, wherein the operations further comprise providing the multidimensional array to a storage device that stores data in chunked format that enables parallel input or parallel output of the multidimensional array.

19. The non-transitory machine-readable medium of claim 18, wherein the providing of the cached multidimensional array to the training engine comprises:
retrieving the multidimensional array from the storage device, resulting in a retrieved multidimensional array; and
providing the retrieved multidimensional array to the training engine.

20. The non-transitory machine-readable medium of claim 18, wherein the storage device comprises a tensor data store.
